(19) United States
(12) Patent Application Publication
(10) Pub. No.: US 2007/0234259 A1
(43) Pub. Date: Oct. 4, 2007

(54) Cell placement in circuit design

(75) Inventors: Anthony D. Drumm, Rochester, MN (US); Pooja M. Kotecha, Wappingers Falls, NY (US); Ruchir Puri, Baldwin Place, NY (US); Louise H. Trevillyan, Katonah, NY (US)

Correspondence Address: HOFFMAN, WARNICK & D'ALESSANDRO LLC, 75 State Street, 14th Floor, ALBANY, NY, 12207, US

(73) Assignee: International Business Machines Corporation, Armonk, NY (US)

(21) Appl. No.: 11/397,586

(22) Filed: Apr. 4, 2006

(51) Int. Cl. G06F 17/50; G06F 9/45

(52) U.S. Cl. 716/9

(57) ABSTRACT

A solution for managing a circuit design, which enables a cell to be incrementally placed in the circuit design based on a resulting wiring distance is provided. A cell to be placed in the circuit design is obtained along with a corresponding set of nets in the circuit design to which the cell is to be connected. A routing grid, which defines a plurality of tiles in the circuit design for consideration in placing the cell, can be generated based on the set of nets for the cell. A wire distance measure can be calculated for each of the tiles in the routing grid using the set of nets. The wire distance measure is then used to identify a target tile for placing the cell. The target tile can be used to find an exact and/or rough placement for the cell.

### FIELD OF THE INVENTION

The invention relates generally to placing cells in a circuit design, and more particularly, to a solution for incrementally placing a cell based on the resulting wire length.

### BACKGROUND OF THE INVENTION

Numerous approaches have been proposed to address cell placement in gate-array and/or standard-cell circuit designs. In general, these approaches assume that the circuit design is largely unplaced, e.g., a relatively small number of important cells, such as arrays or registers, may be pre-placed. In these approaches, cells are globally placed (e.g., anywhere within the circuit design).

The amount of wire required to implement all the connections in the circuit design is an important consideration in current and future silicon technologies. For example, as circuit feature sizes are reduced, wire delay is becoming the dominant source of delay in the resulting circuit designs. Further, wire delay is anti-scaling with feature size. That is, wire delay is becoming both relatively slower as well as actually slower as technology has gone below ninety nanometer feature sizes. As a result, it is important for cell placement to consider the amount of wire required by the placement.

After most or all of the cells in a circuit design have been placed, it is often desirable to add an additional cell and/or optimize the location of one or more cells. For example, it may be desirable to implement a particular set of functionality in a slightly different manner, thereby requiring one or more new cells (e.g., add an inverter in order to replace an AND gate with a NAND gate). However, due to the nature of the algorithms implemented, most current cell placement approaches cannot incrementally place a cell so as to minimize additional wire length.

Some approaches have been proposed to address incremental placement. For example, one approach identifies a bounding box within which the cell should be placed and places the cell in a centroid or weighted centroid of the bounding box. The bounding box can be identified based on the locations of the pins to which the cell is to be connected. An alternative approach is described in the co-owned U.S. Pat. No. 5,825,661, which is hereby incorporated herein by reference. In this approach, a first centroid for the source(s) of the cell input(s) and a second centroid for the sink(s) of the cell output(s) are computed. The cell is then placed within a bounding rectangle defined by the two centroids and along a forty-five degree diagonal line that intersects a placement location calculated from the two centroids.

In view of the foregoing, there exists a need in the art to overcome one or more of the deficiencies indicated herein and/or one or more other deficiencies not expressly discussed herein.

### BRIEF SUMMARY OF THE INVENTION

The invention provides a solution for managing a circuit design, which enables a cell to be incrementally placed in the circuit design based on a resulting wiring distance. A cell to be placed in the circuit design is obtained along with a corresponding set of nets in the circuit design to which the cell is to be connected. A routing grid, which defines a plurality of tiles in the circuit design for consideration in placing the cell, can be generated based on the set of nets for the cell. A wire distance measure can be calculated for each of the tiles in the routing grid using the set of nets. The wire distance measure is then used to identify a target tile for placing the cell. The target tile can be used to find an exact and/or rough placement for the cell.

A first aspect of the invention provides a method of managing a circuit design, the method comprising: obtaining a cell to be placed in the circuit design and a set of nets in the circuit design to which the cell is to be connected; obtaining a routing grid for the cell, the routing grid defining a plurality of tiles in the circuit design; obtaining a wire distance measure for each of the plurality of tiles based on the set of nets; and identifying a target tile in the plurality of tiles for placing the cell based on the corresponding wire distance measures.

A second aspect of the invention provides a system for managing a circuit design, the system comprising: a system for obtaining a cell to be placed in the circuit design and a set of nets in the circuit design to which the cell is to be connected; a system for obtaining a routing grid for the cell, the routing grid defining a plurality of tiles in the circuit design; a system for obtaining a wire distance measure for each of the plurality of tiles based on the set of nets; and a system for identifying a target tile in the plurality of tiles for placing the cell based on the corresponding wire distance measures.

A third aspect of the invention provides a program product stored on a computer-readable medium, which when executed, enables a computer infrastructure to manage a circuit design, the program product comprising computer program code for enabling the computer infrastructure to: obtain a cell to be placed in the circuit design and a set of nets in the circuit design to which the cell is to be connected; obtain a routing grid for the cell, the routing grid defining a plurality of tiles in the circuit design; obtain a wire distance measure for each of the plurality of tiles based on the set of nets; and identify a target tile in the plurality of tiles for placing the cell based on the corresponding wire distance measures.

A fourth aspect of the invention provides a method of generating a system for managing a circuit design, the method comprising: providing a computer infrastructure operable to: obtain a cell to be placed in the circuit design and a set of nets in the circuit design to which the cell is to be connected; obtain a routing grid for the cell, the routing grid defining a plurality of tiles in the circuit design; obtain a wire distance measure for each of the plurality of tiles based on the set of nets; and identify a target tile in the plurality of tiles for placing the cell based on the corresponding wire distance measures.

A fifth aspect of the invention provides a business method for managing a circuit design, the business method comprising managing a computer infrastructure that performs the process described herein; and receiving payment based on the managing.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for managing a circuit design according to an embodiment of the invention.

FIG. 2 shows an illustrative process for placing a cell in a circuit design according to an embodiment of the invention.

FIG. 3 shows an illustrative routing grid for an illustrative circuit design according to an embodiment of the invention.

FIGS. 4A-C show matrices of illustrative net-specific wire distances corresponding to each net shown in FIG. 3 according to an embodiment of the invention.

FIGS. 5A-B show matrices of illustrative wire distance measures that can be generated based on the net-specific wire distances shown in FIGS. 4A-C.

FIG. 6 shows an illustrative placement grid for the circuit design of FIG. 3.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for managing a circuit design, which enables a cell to be incrementally placed in the circuit design based on a resulting wiring distance. A cell to be placed in the circuit design is obtained along with a corresponding set of nets in the circuit design to which the cell is to be connected. A routing grid, which defines a plurality of tiles in the circuit design for consideration in placing the cell, can be generated based on the set of nets for the cell. A wire distance measure can be calculated for each of the tiles in the routing grid using the set of nets. The wire distance measure is then used to identify a target tile for placing the cell. The target tile can be used to find an exact and/or rough placement for the cell. As used herein, unless otherwise noted, the term “set” means one or more (i.e., at least one) and the phrase “any solution” means any now known or later developed solution.

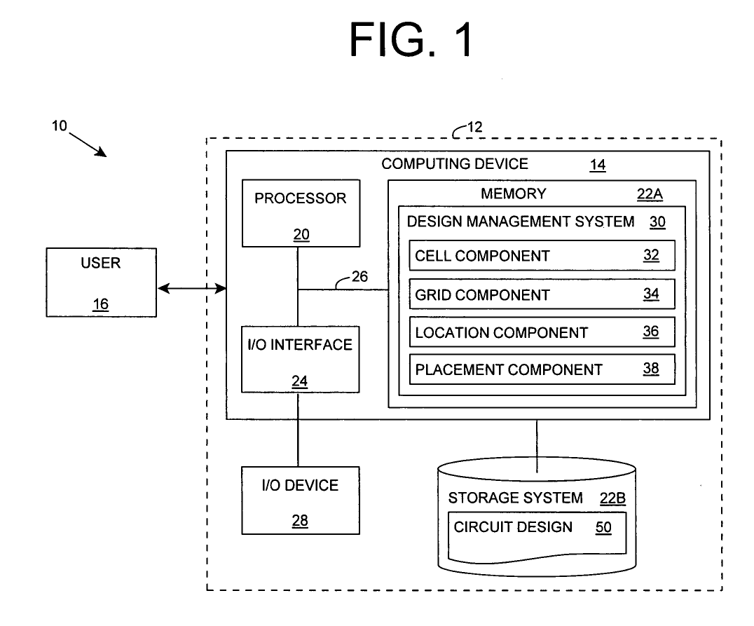

Turning to the drawings, FIG. 1 shows an illustrative environment 10 for managing a circuit design 50 according to an embodiment of the invention. To this extent, environment 10 includes a computer infrastructure 12 that can perform the process described herein in order to manage circuit design 50. In particular, computer infrastructure 12 is shown including a computing device 14 that comprises a design management system 30, which makes computing device 14 operable to manage circuit design 50 by performing the process described herein.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as design management system 30, which is stored in memory 22A and/or storage system 22B. While executing computer program code, processor 20 can read and/or write data, such as circuit design 50, to/from memory 22A, storage system 22B, and/or I/O interface 24. Bus 26 provides a communications link between each of the components in computing device 14. I/O device 28 can comprise any device that enables an individual to interact with computing device 14 or any device that enables computing device 14 to communicate with one or more other computing devices using any type of communications link.

In any event, computing device 14 can comprise any general purpose computing article of manufacture capable of executing computer program code installed thereon (e.g., a personal computer, server, handheld device, etc.). However, it is understood that computing device 14 and design management system 30 are only representative of various possible equivalent computing devices that may perform the process described herein. To this extent, in other embodiments, the functionality provided by computing device 14 and design management system 30 can be implemented by a computing article of manufacture that includes any combination of general and/or specific purpose hardware and/or computer program code. In each embodiment, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of communications link, such as a network, a shared memory, or the like, to perform the process described herein. Further, while performing the process described herein, one or more computing devices in computer infrastructure 12 can communicate with one or more other computing devices external to computer infrastructure 12 using any type of communications link. In either case, the communications link can comprise any combination of various types of wired and/or wireless links; comprise any combination of one or more types of networks (e.g., the Internet, a wide area network, a local area network, a virtual private network, etc.); and/or utilize any combination of various types of transmission techniques and protocols.

As discussed herein, design management system 30 enables computer infrastructure 12 to manage circuit design 50. To this extent, design management system 30 is shown including a cell component 32, a grid component 34, a location component 36, and a placement component 36. Operation of each of these systems is discussed further herein. However, it is understood that some of the various systems shown in FIG. 1 can be implemented independently, combined, and/or stored in memory for one or more separate computing devices that are included in computer infrastructure 12. Further, it is understood that some of the systems and/or functionality may not be implemented, or additional systems and/or functionality may be included as part of computer infrastructure 12.

Regardless, the invention provides a solution for managing circuit design 50. In general, design management system 30 enables one or more users 16 to view, modify, delete, and/or the like, one or more circuit designs 50. To this extent, design management system 30 can read and write data for circuit design 50 to/from storage systems 22A-B using any solution. In one embodiment, data for circuit design 50 is stored as one or more files in a file system, which can define various objects/structures that can be manipulated (e.g., modified, added, deleted, etc.) in a dynamic memory using design management system 30 and subsequently stored in the one or more files. However, it is understood that data for circuit design 50 can be managed using any solution.

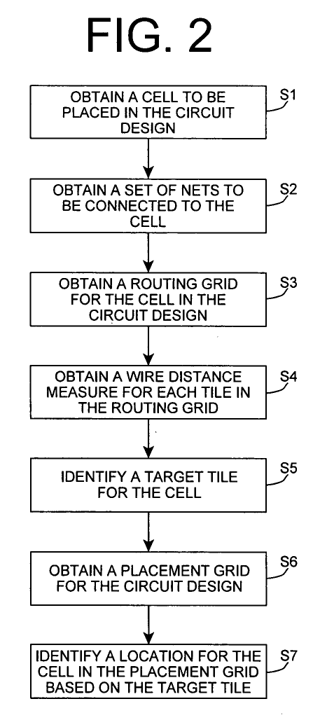

In any event, FIG. 2 shows an illustrative process for placing a cell in circuit design 50 according to an embodiment of the invention, which can be implemented by computer infrastructure 12 (FIG. 1). Referring to FIGS. 1 and 2, in step S1 of FIG. 2, cell component 32 can obtain a cell to be placed in circuit design 50. Cell component 32 can obtain the cell using any solution. For example, cell component 32 can generate a user interface for display to user 16, which renders some or all of circuit design 50. In this case, the user interface can enable user 16 to select a cell to be added to circuit design 50. Similarly, as part of an optimization process for circuit design 50, user 16 can use the user interface to select a particular cell in circuit design 50 for which the location is to be optimized for wiring distance. Further, cell component 32 can define an application program interface (API) or the like that enables user 16, another computing system in this case, to request that a cell be added to circuit design 50 and/or optimized for wiring distance.

In step S2, cell component 32 can obtain a set of nets in circuit design 50 to which the cell is to be connected. As known in the art, a “net” comprises a set of terminals in circuit design 50 that require electrical connection. Further, the “net” can include existing wiring used to connect some or all of the set of terminals. In general, each cell in circuit design 50 will comprise a unique net for each input and each output for the cell. Cell component 32 can obtain the set of nets for the cell using any solution. For example, user 32 can designate (e.g., using a user interface, API, or the like) the source terminal corresponding to each input of the cell, and the sink terminal corresponding to each output of the cell. Additionally, when the cell is currently included in circuit design 50, cell component 32 can automatically determine the source/sink terminal(s) for the cell using the existing wiring information in circuit design 50. In this case, cell component 32 can remove any wiring information included in each net that is only used to connect the cell being placed.

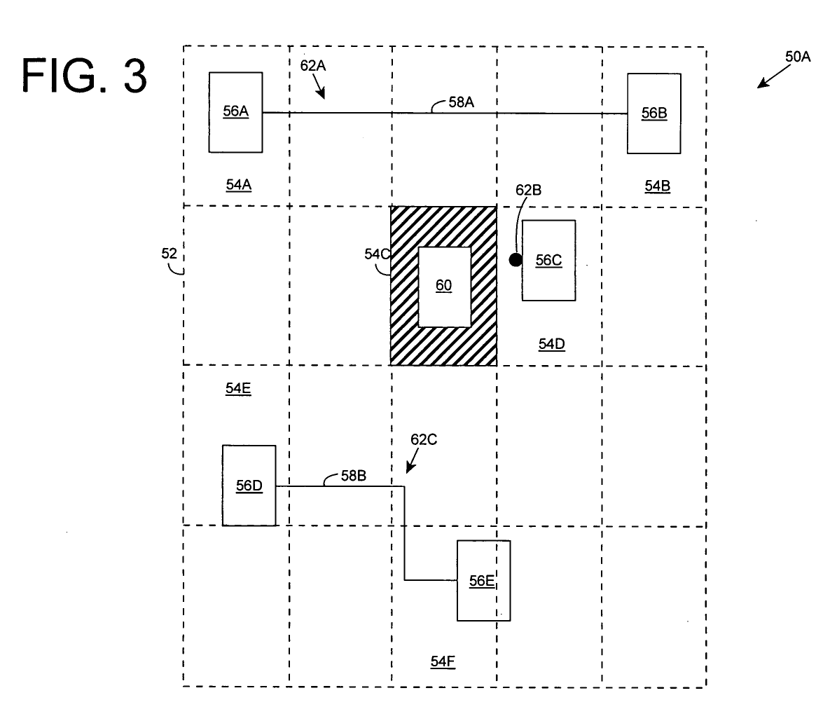

In step S3, grid component 34 can obtain a routing grid for the cell in circuit design 50. For example, FIG. 3 shows an illustrative routing grid 52 for an illustrative circuit design 50A according to an embodiment of the invention. Routing grid 52 defines a plurality of tiles, such as tiles 54A-F, in circuit design 50A. As shown, routing grid 52 can comprise a rectangular shape, in which each tile 54A-F is also a rectangular shape. However, any desired shape for routing grid 52 and tiles 54A-F can be used.

In one embodiment, grid component 34 (FIG. 1) defines an area for routing grid 52 based on the locations of the source terminal(s) and/or sink terminal(s) for the cell being placed. For example, circuit design 50A is shown including cells 56A-E and wiring information 58A-B. Cell 60, which is to be placed in circuit design 50A, can have two inputs for which the source terminals are at cells 56A and 56D, and a single output for which the sink terminal is at cell 56C. In this case, grid component 34 can define a bounding area for placing cell 60 as, for example, a smallest rectangle that includes all the terminals for cell 60 (e.g., cells 56A, 56D, and 56E). Subsequently, grid component 34 can define an area for routing grid 52 based on the bounding area (e.g., must include at least the bounding area).

Next, grid component 34 (FIG. 1) can divide the area for routing grid 52 into a number of tiles 54A-F. To this extent, grid component 34 can adjust an actual size and/or location of routing grid 52 based on a desired size of each tile 54A-F included therein (e.g., to fit a whole number of vertical and/or horizontal tiles). Grid component 34 can determine the size of each tile 54A-F using any solution. In general, a smaller tile size will result in a more exact placement of cell 60, but increase a run time for placing cell 60. In one embodiment, grid component 34 selects a size for each tile 54A-F based on a size of cell 60 (e.g., as a multiple of the size). For example, a width of each tile 54A-F can be made twice the width of cell 60, while a height of each tile 54A-F can be made twice the height of cell 60. Alternatively, grid component 34 can use a predefined number and/or maximum number of horizontal and/or vertical tiles 54A-F for routing grid 52 to determine the corresponding dimensions of each tile 54A-F.

In step S4 (FIG. 2), location component 36 (FIG. 1) can obtain a wire distance measure for each of the plurality of tiles 54A-F based on the set of nets for cell 60. For example, as discussed above, cell 60 can include two inputs having sources at cells 56A and 56D and an output having a sink at cell 56C. In this case, cell 60 can have three nets, defined as: net 62A, which includes the output of cell 56A, wiring information 58A, and the input of cell 56B; net 62B, which includes the input of cell 56C; and net 62C, which includes the output of cell 56D, wiring information 58B, and the input of cell 56E.

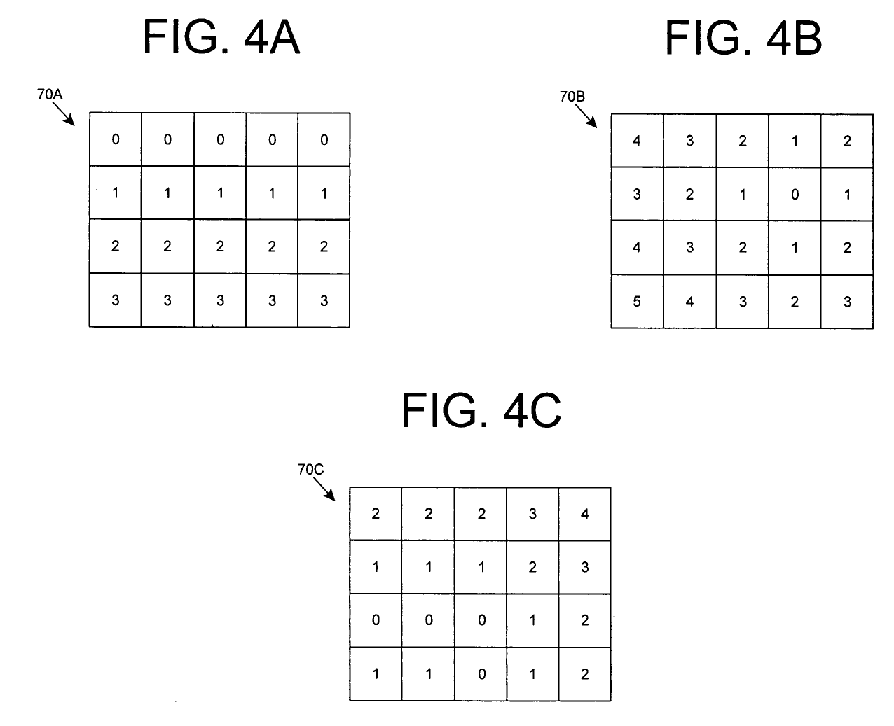

To obtain the wire distance measure for each tile 54A-F, location component 36 (FIG. 1) can obtain a net-specific wire distance for each tile 54A-F and each net. For example, FIGS. 4A-C show matrices 70A-C for illustrative net-specific wire distances corresponding to each net 62A-C (FIG. 3), respectively, according to an embodiment of the invention. Referring to FIGS. 3 and 4A-C, each matrix 70A-C includes a value that corresponds to the wire distance that each tile 54A-F in routing grid 52 is from the corresponding net 62A-C. Location component 36 can determine the net-specific wire distance values for matrices 70A-C using any solution.

For example, location component 36 (FIG. 1) can assign a wire distance of zero to each tile 54A-F through which the corresponding net 62A-C passes. For every other tile 54A-F, location component 36 can determine the wire distance based on an amount of wire that would be required to reach a tile 54A-F having a wire distance of zero. In this case, location component 36 can use any wire routing measure. In one embodiment, location component 36 uses a rectilinear wire routing solution (e.g., Steiner, global, track, detailed, and/or the like) in which wiring layers are either vertical or horizontal and actual routes are represented as segments of horizontal and vertical wire.

To this extent, location component 36 (FIG. 1) can obtain the wire distance for each tile 54A-F based on a set of tile movements required to reach a tile having a distance of zero. For example, each tile can comprise a rectangular area and location component 36 can use a weighted count based on the tile dimensions and direction of the movement. For example, grid 52 includes tiles 54A-F that have a height that is approximately 1.5 times the width. In this case, location component 36 can increment the value for the wire distance by 1.5 for every vertical tile movement, and increment the value for the wire distance by 1 for every horizontal tile movement. It is understood that the relative height and width for tiles 54A-F are only illustrative and any ratio can be used for the dimensions of tiles 54A-F. Regardless, in order to simplify the illustrative values in matrices 70A-C and the discussion herein, each value in matrices 70A-C is calculated by incrementing the wire distance by 1 for each vertical or horizontal tile movement.

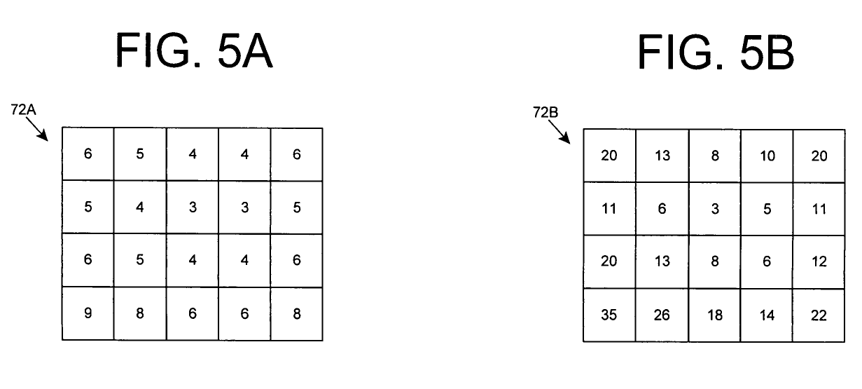

Subsequently, location component 36 (FIG. 1) can combine each net-specific wire distance for each tile 54A-F to generate the wire distance measure for the corresponding tile 54A-F. FIGS. 5A-B show matrices 72A-B of illustrative wire distance measures that can be generated based on the net-specific wire distances shown in matrices 70A-C (FIGS. 4A-C). In matrix 72A, location component 36 calculates each wire distance measure by adding the corresponding net-specific wire distances for each tile 54A-F. Alternatively, location component 36 can account for one or more other considerations in placing cell 60 (FIG. 3). For example, in order to account for RC delay, which impacts the timing in circuit design 50 (FIG. 1), location component 36 can calculate each wire distance measure by first squaring each net-specific wire distance for each tile 54A-F and then adding the squared net-specific wire distances, resulting in the wire distance measures shown in matrix 72B.

Returning to FIG. 3, in generating the wire distance measure, location component 36 (FIG. 1) can use a weighted (biased) combination of the net-specific wire distances. In particular, one or more characteristics of a net 62A-C can be used to assign a relative weight to the net, which is then used in generating the wire distance measure. For example, a particular net, such as net 62A, may include one or more cells 56A-B that have not been placed in circuit design 50A. In this case, the sources for an unplaced cell 56A-B can be used to generate net 62A for placing cell 60. Further, net 62A can be weighted less than nets 62B-C and/or not used in generating the wire distance measure. For example, the net-specific wire distance for net 62A can be divided by a number of levels of logic required to reach placed sources (e.g., two when one cell is not placed). Similarly, one or more of nets 62A-C could comprise a critical net. In this case, delay for the critical net should be minimized, and therefore the critical net can be assigned a higher weight. Conversely, a non-critical or a net having a relatively long wiring can be assigned a lower weight. Location component 36 can use any solution for implementing relative weights. For example, one or more net-specific wire distances can be multiplied/divided by a corresponding weight to enhance and/or reduce its influence on the overall wire distance measure.

In any event, returning to FIGS. 1 and 2, in step S5, location component 36 can identify a target tile for the cell. In particular, location component 36 can identify the target tile having the wire distance measure that corresponds to the least amount of wire that would be required (e.g., the lowest value for the wire distance measure). For example, using the set of wire distance measures in FIG. 5B and routing grid 52 in FIG. 3, tile 54C would be identified as the target tile. However, using the set of wire distance measures in FIG. 5A and routing grid 52 in FIG. 3, tile 54C and tile 54D have the same wire distance measure, which is the lowest of all the tiles. In this case, one or more heuristics can be used to identify the target tile.

Location component 36 can use any type of heuristic technique in selecting the target tile. In one embodiment, location component 36 selects the tile that is closer to a center of routing grid 52 (FIG. 3), which can correspond to the center of a bounding area on which routing grid 52 is based. However, location component 36 can implement various other heuristics. For example, the target tile can be selected based on a distance to a centroid of the source(s)/sink(s) to which cell 60 (FIG. 3) is to be connected, based on a density in tiles 54C-D, randomly, arbitrarily, etc. Further, it is understood that multiple heuristics can be combined and/or used in a manner to break ties should another heuristic fail to select one tile over the other(s).

In any event, once a target tile, such as tile 54C (FIG. 3), has been identified, placement component 38 can place cell 60 (FIG. 3) in circuit design 50A (FIG. 3) based on target tile 54C. For example, placement component 38 can identify an area within target tile 54C that is large enough to fit cell 60. In one embodiment, target tile 54C is used to obtain an approximate area for cell 60, which is then correlated with available locations for cell 60.

Placement of cell 60 (FIG. 3) can be performed at any level of detail. In particular, the placement can comprise an exact placement for cell 60. In one embodiment, a placement service can be used to identify a set of locations in which cell 60 can be placed without disturbing other cells in circuit design 50A. In this case, placement component 38 can provide target tile 54C to the placement service, which can use a placement blockage map or the like to select the set of locations within/close to target tile 54C. Placement component 38 can select a location from the set of locations that is best for wiring and/or timing.

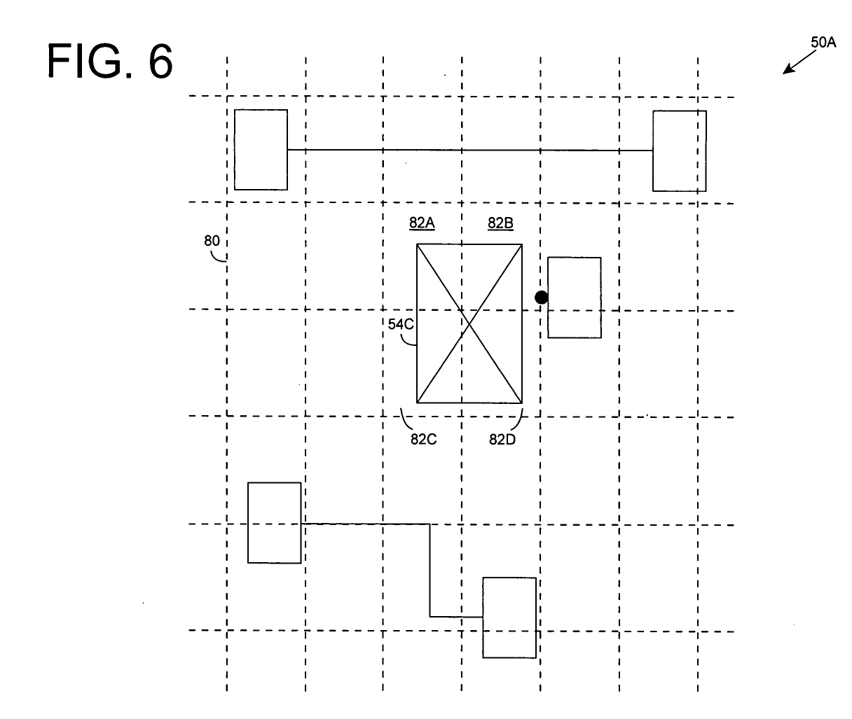

Placement also can comprise a rough placement for cell 60 (FIG. 3). To this extent, in step S6, placement component 38 can obtain a placement grid for circuit design 50A, and in step S7, placement component 38 can identify a location in the placement grid for placing cell 60 based on target tile 54C. FIG. 6 shows an illustrative placement grid 80 for circuit design 50A. Placement grid 80 includes a set of locations, such as locations 82A-D, within which a cell can be placed. Placement component 38 (FIG. 1) can use any solution to select a location 82A-D in placement grid 80 based on target tile 54C. In one embodiment, placement component 38 maps a center of target tile 54C to the corresponding location 82D within which it is located, and selects the location 82D for placing cell 60 (FIG. 3). Placement component 38 can determine if the set of available resources (e.g., space, wiring, power, etc.) for location 82D are sufficient to include cell 60. If so, then cell 60 can be located in location 82D.

When location 82D does not include sufficient resources for cell 60 (FIG. 3), placement component 38 (FIG. 1) can use any solution to select another location 82A-C. For example, placement component 38 can select a location 82A-C in which at least a portion of target tile 54C is located. Such a location 82A-C can be selected using any heuristic, such as in a spiral manner. If cell 60 cannot be placed in any locations 82A-D corresponding to target tile 54C, then placement component 38 can select another location based on another tile. For example, location component 36 can identify an alternative target tile, such as tile 54D (FIG. 3), using any heuristic (e.g., second lowest wire distance measure) and placement component 38 can select locations corresponding to tile 54D. Further, placement component 38 can select adjacent locations in a spiral manner until a location having sufficient resources for cell 60 is located.

As discussed herein, various systems and components are described as “obtaining” data (e.g., circuit design, cell to be placed, grid(s), etc.). It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

While shown and described herein as a method and system for managing a cell design, it is understood that the invention further provides various alternative embodiments. For example, in one embodiment, the invention provides a program product stored on a computer-readable medium, which when executed, enables a computer infrastructure to manage a cell design. To this extent, the computer-readable medium includes program code, such as design management system 30 (FIG. 1), which implements the process described herein. It is understood that the term “computer-readable medium” comprises one or more of any type of tangible medium of expression (e.g., physical embodiment) of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), as a data signal traveling over a network (e.g., during a wired/wireless electronic distribution of the program product), on paper (e.g., capable of being scanned in as electronic data), and/or the like.

In another embodiment, the invention provides a method of generating a system for managing a circuit design. In this case, a computer infrastructure, such as computer infrastructure 12 (FIG. 1), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising, and/or fee basis. That is, a service provider, such as an application service provider, could offer to manage a circuit design as described herein. In this case, the service provider can manage (e.g., create, maintain, support, etc.) a computer infrastructure, such as computer infrastructure 12 (FIG. 1), that performs the process described herein for one or more customers. In return, the service provider can receive payment from the customer(s) under a subscription and/or fee agreement, receive payment from the sale of advertising to one or more third parties, and/or the like.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a circuit design, the method comprising:
obtaining a cell to be placed in the circuit design and a set of nets in the circuit design to which the cell is to be connected;
obtaining a routing grid for the cell, the routing grid defining a plurality of tiles in the circuit design;
obtaining a wire distance measure for each of the plurality of tiles based on the set of nets; and
identifying a target tile in the plurality of tiles for placing the cell based on the corresponding wire distance measures.

2. The method of claim 1, further comprising:
obtaining a placement grid for the circuit design; and
identifying a location in the placement grid for placing the cell based on the target tile.

3. The method of claim 2, the identifying a location being further based on a set of available resources for each location in the placement grid.

4. The method of claim 1, the obtaining a routing grid including:
identifying a bounding area for placing the cell in the circuit design; and
generating the routing grid based on the bounding area and a size of the cell.

5. The method of claim 1, the obtaining a wire distance measure including:
for each net in the set of nets, obtaining a net-specific wire distance for each of the plurality of tiles; and
for each of the plurality of tiles, combining each net-specific wire distance to generate the wire distance measure for the corresponding tile.

6. The method of claim 5, the obtaining a net-specific wire distance including:
assigning a distance of zero for each tile through which the corresponding net passes; and
determining, for every other tile, a distance based on a set of tile movements required to reach a tile having a distance of zero.

7. The method of claim 5, the combining including, for each tile:
squaring the net-specific wire distance for each net in the set of nets; and
adding the squared net-specific wire distances to obtain the wire distance measure for the corresponding tile.

8. The method of claim 1, the obtaining a wire distance measure including obtaining a relative weight for each net in the set of nets, the wire distance measure being further based on the relative weights corresponding to each net.

9. A system for managing a circuit design, the system comprising:
a system for obtaining a cell to be placed in the circuit design and a set of nets in the circuit design to which the cell is to be connected;
a system for obtaining a routing grid for the cell, the routing grid defining a plurality of tiles in the circuit design;
a system for obtaining a wire distance measure for each of the plurality of tiles based on the set of nets; and
a system for identifying a target tile in the plurality of tiles for placing the cell based on the corresponding wire distance measures.

10. The system of claim 9, further comprising:
a system for obtaining a placement grid for the circuit design; and
a system for identifying a location in the placement grid for placing the cell based on the target tile.

11. The system of claim 9, the system for obtaining a routing grid including:
a system for identifying a bounding area for placing the cell in the circuit design; and
a system for generating the routing grid based on the bounding area and a size of the cell.

12. The system of claim 9, the system for obtaining a wire distance measure including:
a system for obtaining a net-specific wire distance for each of the plurality of tiles and each net in the set of nets; and
a system for combining each net-specific wire distance to generate the wire distance measure for each of the plurality of tiles.

13. The system of claim 12, the system for combining including, for each tile:
a system for squaring the net-specific wire distance for each net in the set of nets; and
a system for adding the squared net-specific wire distances to obtain the wire distance measure for the corresponding tile.

14. The system of claim 9, the system for obtaining a wire distance measure including a system for obtaining a relative weight for each net in the set of nets, the wire distance measure being further based on the relative weights corresponding to each net.

15. A program product stored on a computer-readable medium, which when executed, enables a computer infrastructure to manage a circuit design, the program product comprising computer program code for enabling the computer infrastructure to:
obtain a cell to be placed in the circuit design and a set of nets in the circuit design to which the cell is to be connected;
obtain a routing grid for the cell, the routing grid defining a plurality of tiles in the circuit design;
obtain a wire distance measure for each of the plurality of tiles based on the set of nets; and
identify a target tile in the plurality of tiles for placing the cell based on the corresponding wire distance measures.

16. The program product of claim 15, further comprising computer program code for enabling the computer infrastructure to:
obtain a placement grid for the circuit design; and
identify a location in the placement grid for placing the cell based on the target tile.

17. The program product of claim 15, the computer program code for enabling the computer infrastructure to obtain a routing grid including computer program code for enabling the computer infrastructure to:
identify a bounding area for placing the cell in the circuit design; and
generate the routing grid based on the bounding area and a size of the cell.

18. The program product of claim 15, the computer program code for enabling the computer infrastructure to obtain a wire distance measure including computer program code for enabling the computer infrastructure to:
for each net in the set of nets, obtain a net-specific wire distance for each of the plurality of tiles; and
for each of the plurality of tiles, combine each net-specific wire distance to generate the wire distance measure for the corresponding tile.

19. The program product of claim 15, the computer program code for enabling the computer infrastructure to obtain a wire distance measure including computer program code for enabling the computer infrastructure to obtain a relative weight for each net in the set of nets, the wire distance measure being further based on the relative weights corresponding to each net.

20. A method of generating a system for managing a circuit design, the method comprising:
providing a computer infrastructure operable to:
obtain a cell to be placed in the circuit design and a set of nets in the circuit design to which the cell is to be connected;
obtain a routing grid for the cell, the routing grid defining a plurality of tiles in the circuit design;
obtain a wire distance measure for each of the plurality of tiles based on the set of nets; and
identify a target tile in the plurality of tiles for placing the cell based on the corresponding wire distance measures.
